(19) United States
(12) Patent Application Publication
(10) Pub. No.: US 2025/0132413 A1
(43) Pub. Date: Apr. 24, 2025

(54) SECONDARY BATTERY MODULE

(71) Applicant: DIC Corporation, Tokyo (JP)

(72) Inventors: Kenichi Fujisaki, Saitama (JP); Kyouichi Toyomura, Tokyo (JP)

(73) Assignee: DIC Corporation, Tokyo (JP)

(21) Appl. No.: 18/730,521

(22) PCT Filed: Sep. 15, 2022
(86) PCT No.: PCT/JP2022/034507

§ 371 Date: Jul. 19, 2024

(30) Foreign Application Priority Data
Feb. 4, 2022 (JP) 2022-016441

(51) Int. Cl. H01M 10/6555; H01M 10/658; H01M 10/659

(52) U.S. Cl. CPC H01M 10/6555; H01M 10/658; H01M 10/659

(57) ABSTRACT

The present invention relates to a secondary battery module including a heat-absorbing sheet including a heat-absorbing agent and sandwiched between battery cells. The configuration of the present invention can suppress a rapid temperature rise of a secondary battery due to heat generation during high-speed charging and high-output discharging, internal short circuits, or the like, minimize damage such as ignition and smoking due to thermal runaway, and prevent or delay the chain explosion to other battery cells by absorbing and extinguishing the heat from battery cells that have reached abnormally high temperature. In addition, the expansion of the battery cell itself caused by the heat generation and temperature rise described above can be suppressed.

### TECHNICAL FIELD

The present invention relates to a secondary battery module.

### BACKGROUND ART

In response to the miniaturization of personal computers, cellular phones, video cameras, and the like, the demand for smaller and lighter batteries increases, and secondary batteries having high-performance are becoming popular. A lithium-ion secondary battery, for example, is also used as an on-vehicle power source for electric or hybrid vehicles, improvements in various performance have been made, and, in particular, in recent years, the capacity of the secondary battery has been increasing.

With such high capacity, when the temperature of the secondary battery rises due to heat generation during high-speed charging or high-output discharging, there is a risk of ignition or damage to the battery due to a rapid temperature rise or thermal runaway. As for the secondary battery, internal short circuits or the like sometimes also cause thermal runaway, resulting in problems such as ignition or smoking. In the future, as ultra-fast charging speeds continue to increase, the amount of heat generated is expected to increase even higher, and there is a need to develop methods of suppressing a temperature rise for enhancing the safety of the secondary battery.

As an exterior material that can house and seal each component such as a positive electrode material, a negative electrode material, a separator, and an electrolyte, configuring a lithium-ion secondary battery, an exterior film which is lightweight and can be freely selected in shape is actively being developed, unlike a case made of metal conventionally used. The exterior film, for example, has a basic configuration which is a multilayer structure including a substrate layer, a metal layer, and a sealant layer laminated in this order, and can be processed into containers by heat-sealing the sealant layers each other, and, for example, an exterior film for a battery having excellent fire resistance (see PLT 1) has been disclosed.

Battery cells in which at least part of an outside of the battery cell is covered with a fire resistant coating (see PLT 2) and portable electronic devices in which an insulation layer including specific heat-absorbing inorganic compound particles and a binding agent is provided on a surface of a fitting part of a secondary battery (see PLT 3) have also been proposed.

### CITATION LIST

### Patent Literature

PLT 1: Japanese Unexamined Patent Application Publication No. 2021-2425
PLT 2: Japanese Unexamined Patent Application Publication (Translation of PCT Application) No. 2013-528911
PLT 3: Japanese Patent No. 5643648

### SUMMARY OF INVENTION

### Technical Problem

However, there are problems that, as in PLTs 1 to 3, when the function of absorbing generated heat is imparted to an exterior part which houses and seals the secondary battery, the content of a heat-absorbing agent is limited due to strength limitations such as thickness and flexibility, and the heat-absorbing effect is not sufficient.

An object of the present invention is to provide a secondary battery module which can suppress a rapid temperature rise of a secondary battery due to heat generation during high-speed charging or high-output discharging, and prevent ignition or damage due to thermal runaway.

### Solution to Problem

The present invention relates to the following (1) to (8).

(1) A secondary battery module including a heat-absorbing sheet including a heat-absorbing agent and sandwiched between battery cells. (2) The secondary battery module according to (1), in which the heat-absorbing sheet is a heat-absorbing sheet having a void part. (3) The secondary battery module according to (1) or (2), in which the heat-absorbing sheet is a heat-absorbing sheet further including a heat storage material. (4) The secondary battery module according to any one of (1) to (3), in which the heat-absorbing sheet is a heat-absorbing sheet further including a flame shielding layer. (5) The secondary battery module according to any one of (1) to (4), in which the heat-absorbing sheet is a heat-absorbing sheet further having adhesive layers on outermost layers on both sides, and the battery cells are fixed by the adhesive layers. (6) The secondary battery module according to any one of (1) to (5), in which the heat-absorbing agent included in the heat-absorbing sheet is at least one or more kinds selected from the group consisting of inorganic hydrates, metal hydroxides, and carbonates. (7) The secondary battery module according to any one of (1) to (6), in which the heat-absorbing sheet is a heat-absorbing sheet including two or more kinds of heat-absorbing agents. (8) The secondary battery module according to any one of (1) to (7), in which the heat-absorbing sheet is a heat-absorbing sheet having a total thickness in a range of 100 to 20,000 μm.

### Advantageous Effects of Invention

According to the present invention, a secondary battery module which can suppress a rapid temperature rise of a secondary battery due to heat generation during high-speed charging or high-output discharging, and prevent ignition or damage due to thermal runaway can provided.

### BRIEF DESCRIPTION OF DRAWINGS

FIG. 1 is a schematic cross-sectional view of an example of a heat-absorbing sheet provided in a secondary battery module of the present invention.

FIG. 2 is a schematic cross-sectional view of an example of a heat-absorbing sheet provided in a secondary battery module of the present invention.

FIG. 3 is a DSC curve of a heat-absorbing sheet 1 obtained in Production Example 1.

FIG. 4 is a DSC curve of a heat-absorbing sheet 2 obtained in Production Example 2.

FIG. 5 is a DSC curve of a heat-absorbing sheet 3 obtained in Production Example 3.

FIG. 6 is a DSC curve of a heat-absorbing sheet 4 obtained in Production Example 4.

FIG. 7 is a DSC curve of a heat-absorbing sheet 5 obtained in Production Example 5.

FIG. 8 is a chart showing a temperature change obtained from a test of heat absorption characteristics 2.

FIG. 9 is a chart showing a temperature change obtained from a test of heat absorption characteristics 3.

### DESCRIPTION OF EMBODIMENTS

Hereinafter, the embodiment of the present invention will be described in detail. Note that, in this specification, a numerical value range indicated using “to” indicates a range which includes the numerical values listed before and after “to” as a minimum value and a maximum value, respectively.

The present invention is a secondary battery module including a heat-absorbing sheet including a heat-absorbing agent and sandwiched between battery cells. The configuration of the present invention can suppress a rapid temperature rise of a secondary battery due to heat generation during high-speed charging and high-output discharging, internal short circuits, or the like, minimize damage such as ignition and smoking due to thermal runaway, and prevent or delay the chain explosion to other battery cells by absorbing and extinguishing the heat from battery cells that have reached abnormally high temperature. In addition, an expansion of the battery cell itself caused by heat generation and a temperature rise described above can be suppressed.

Hereinafter, a heat-absorbing sheet configuring a secondary battery module of the present invention will be described.

### [Heat-Absorbing Sheet]

A heat-absorbing sheet has a layer including a heat-absorbing agent and a resin as a matrix. The heat-absorbing sheet may be a single layer sheet having only a layer including a heat-absorbing agent and a resin. The heat-absorbing sheet may also be a laminate further having an adhesive agent layer, a flame shielding layer, or a layer having any other configuration as described below.

Hereinafter, unless otherwise specified, a single layer sheet only having a layer including a heat-absorbing agent and a resin is referred to as a “heat-absorbing sheet”.

### <Heat-Absorbing Agent>

Examples of the heat-absorbing agents preferably include inorganic hydrates, metal hydroxides, and carbonates having heat absorption peaks at temperatures of 80° C. or higher. Specific examples thereof include calcium sulfate dihydrate, magnesium sulfate heptahydrate, sodium bicarbonate, aluminum hydroxide, magnesium hydroxide, calcium hydroxide, calcium carbonate, hydrotalcite, and zinc borate hydrate. Among those, at least one kind selected from the group consisting of calcium sulfate dihydrate, sodium hydrogen carbonate, aluminum hydroxide, magnesium hydroxide, and calcium carbonate is preferred, and at least one kind selected from the group consisting of calcium sulfate dihydrate, sodium hydrogen carbonate, and aluminum hydroxide is more preferred. In particular, as the heat-absorbing agent, calcium sulfate dihydrate (gypsum) and sodium hydrogen carbonate (sodium bicarbonate) are more preferably used because of exhibiting a heat absorption effect at a level that can more effectively prevent ignition and damage of the secondary battery due to thermal runaway even when the temperature of the battery cells or the like rises in a short time (for example, in a case such that the temperature reaches 800° C. within a few seconds). Calcium sulfate dihydrate (gypsum) is particularly preferably used because, in addition to the above effects, it maintains excellent water resistance. The heat-absorbing agent may be used alone or in combination of two or more kinds.

The heat absorption starting temperature of the heat-absorbing agent is preferably in a range of 60° C. to 750° C., more preferably in a range of 80° C. to 450° C., and even more preferably in a range of 80° C. to 300° C.

The heat absorption peak temperature of the heat-absorbing agent is preferably in a range of 80° C. to 800° C., more preferably in a range of 100° C. to 500° C., and even more preferably in a range of 100° C. to 350° C.

The heat absorption amount of the heat-absorbing agent is preferably in a range of 100 J/g to 1,200 J/g, and more preferably in a range of 300 J/g to 1,200 J/g.

Note that the heat absorption starting temperature, the heat absorption peak temperature, and the heat absorption amount of each heat-absorbing agent are values obtained by the method in Examples described below using a differential scanning calorimetry analyzer (DSC).

The heat-absorbing sheet may include one kind of heat-absorbing agent alone or may include two or more kinds of heat-absorbing agents. In a case where the heat-absorbing sheet includes two or more kinds of heat-absorbing agents, it is preferable to combine two or more kinds of heat-absorbing agents having different heat absorption starting temperatures or different heat absorption peak temperatures. For example, in a case where the heat-absorbing agent (heat-absorbing agent 1) having relatively low heat absorption starting temperature or heat absorption peak temperature is mixed with the heat-absorbing agent (heat-absorbing agent 2) having a relatively high heat absorption starting temperature or heat absorption peak temperature for use, a heat-absorbing reaction continuously occurs during a process of temperature rise, and thermal runaway can effectively be suppressed. As to the secondary battery, for example, an electrolyte often burns, and the electrolyte burns by catching fire or ignition, but when the heat-absorbing sheet includes two or more kinds of heat-absorbing agents, more effective fire extinguishing can be achieved by using the heat-absorbing agents having the heat absorption starting temperatures corresponding to a flash point and an ignition point.

The heat absorption starting temperatures of the heat absorbers 1 and 2 preferably differ by 50° C. or more, and more preferably differ by 100° C. or more. Alternatively, the heat absorption peak temperatures of the heat-absorbing agents 1 and 2 preferably differ by 50° C. or more, and more preferably differ by 100° C. or more.

When the heat-absorbing sheet includes two or more kinds of heat-absorbing agents, for example, the mass ratio of the content of each heat-absorbing agent is not particularly limited in a case of including the heat-absorbing agents 1 and 2, and the mass ratio of heat-absorbing agent 1/heat-absorbing agent 2 can appropriately be set in a range of 10/90 to 90/10.

The particle size of the heat-absorbing agent is preferably in a range of 1 μm to 100 μm, and more preferably in a range of 1 μm to 80 μm. When the particle size of the heat-absorbing agent is within the range described above, the heat-absorbing agent is easily dispersed uniformly in the heat-absorbing sheet, resulting in advantageous from the viewpoint of being able to increase the blended mount.

Note that the particle size of the heat-absorbing agent is a value of a median diameter (D50) measured by a laser diffraction/scattering type particle size distribution analyzer.

### <Resin>

Examples of the resins in the layers including the heat-absorbing agents and the resins configuring the heat-absorbing sheet include thermoplastic resins, thermosetting resins, and elastomer resins.

Examples of the thermoplastic resins include synthetic resins such as polyolefin resins such as polypropylene resins, polyethylene resins, poly(1-butene) resins, polyisobutylene resins, and polypentene resins; polyester resins such as polyethylene terephthalate; polystyrene resins, acrylonitrile-butadiene-styrene (ABS) resins, acrylic resins, polyvinyl acetal resins, polyvinyl alcohol resins, ethylene-vinyl acetate copolymer (EVA) resins, polycarbonate resins, polyphenylene ether resins, polyamide resins, polyvinyl chloride resins (PVC), novolac resins, and polyurethane resins.

Examples of thermosetting resins include synthetic resins such as epoxy resins, urethane resins, phenol resins, urea resins, melamine resins, unsaturated polyester resins, and polyimides.

Examples of the elastomer resins include acrylonitrile-butadiene rubbers, ethylene-propylene-diene rubbers (EPDM), ethylene-propylene rubbers, natural rubbers, polybutadiene rubbers, polyisoprene rubbers, polystyrene-polybutadiene diblock copolymers or hydrogenated products thereof, polystyrene-polybutadiene-polystyrene triblock copolymers or hydrogenated products thereof, polystyrene-polyisoprene diblock copolymers or hydrogenated products thereof, and polystyrene-polyisoprene-polystyrene triblock copolymers or hydrogenated products thereof.

These resins may be used alone or in combination of two or more kinds. The thermoplastic resins are preferred among the above resins from the viewpoint of improving the dispersibility of the heat-absorbing agent in the resin and the mechanical strength of the layer including the heat-absorbing agent and the resin.

In addition, emulsion resins which can form a void part by mechanical foaming are preferred from the viewpoint that, in the layer including the heat-absorbing agent and the resin, a structure having the void part can be easily formed and the porosity can be easily ensured. Examples of the emulsion resins include acrylic-based emulsion resins, urethane-based emulsion resins, ethylene-vinyl acetate-based emulsion resins, vinyl chloride-based emulsion resins, and epoxy-based emulsion resins. Among those, acrylic-based emulsion resins are preferred because of their excellent heat resistance and thermal insulation properties.

Examples of the acrylic resins include resins obtained by polymerizing monomer components containing (meth)acrylic acid alkyl esters. Note that, in this specification, the term “(meth)acrylic” is a generic term for acrylic, methacrylic, and both of them. The term “(meth)acrylate” is a generic term for acrylate, methacrylate, and both of them.

Examples of (meth)acrylic acid alkyl esters include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl(meth)acrylate, hexyl(meth)acrylate, heptyl(meth)acrylate, 2-ethylhexyl (meth)acrylate, n-octyl (meth)acrylate, isooctyl (meth)acrylate, nonyl(meth)acrylate, decyl(meth)acrylate, undecyl(meth)acrylate, dodecyl (meth)acrylate, tridecyl(meth)acrylate, and tetradecyl(meth)acrylate. These may be used alone or in combination of two or more kinds.

In addition to the above-mentioned (meth)acrylic acid alkyl esters, a polar group-containing monomers may be included as monomer components for obtaining an acrylic resin. Examples of the polar group-containing monomers include carboxylic acids having an ethylenically unsaturated group such as (meth)acrylic acid and itaconic acid; (meth)acrylates having a hydroxyl group such as 2-hydroxyethyl (meth)acrylate, 2-hydroxypropyl (meth)acrylate, 4-hydroxybutyl (meth)acrylate, caprolactone-modified (meth)acrylate, polyoxyethylene(meth)acrylate, and polyoxypropylene(meth)acrylate; and nitrogen-containing monomers having an ethylenically unsaturated group such as (meth)acrylonitrile, N-vinylpyrrolidone, N-vinylcaprolactam, N-vinyllaurylolactam, (meth)acryloyl morpholine, (meth)acrylamide, dimethyl(meth)acrylamide, N-methylol(meth)acrylamide, N-butoxymethyl(meth)acrylamide, and dimethylaminomethyl (meth)acrylate.

As the acrylic resins, polymethyl (meth)acrylate and polyethyl(meth)acrylate are preferred, and polymethyl (meth)acrylate is more preferred, and polymethyl methacrylate (PMMA) is even more preferred.

The weight average molecular weight of the acrylic resin is preferably 1,000 to 100,000, more preferably 5000 to 90,000, and even more preferably 20,000 to 80,000 from the viewpoint of easily dispersing the heat-absorbing agent in the heat-absorbing sheet and improving the mechanical strength of the heat-absorbing sheet. Here, the weight average molecular weight is a weight average molecular weight in terms of standard polystyrene measured by gel permeation chromatography (GPC).

The average particle size of the emulsion resin is preferably 30 nm to 1,500 nm and more preferably 50 and 1,000 nm from the viewpoint of being easy to coat the heat-absorbing agent and suitably bind the heat-absorbing agent coated with the resin. Note that the average particle size of the emulsion resin can be defined as the 50% median diameter measured by a dynamic light scattering method, for example, the 50% median diameter on a basis of the volume as measured by a Microtrac UPA type particle size distribution analyzer manufactured by Nikkiso Co., Ltd.

The heat-absorbing sheet preferably has a structure in which the heat-absorbing agent is dispersed in the resin as a matrix.

In addition, the heat-absorbing sheet preferably has a structure having a void part. In this case, the specific gravity of the heat-absorbing sheet is preferably 0.15 to 1.6, and is more preferably 0.2 to 1.0. When the heat-absorbing sheet configuring the secondary battery module of the present invention is a heat-absorbing sheet having a void part, its thermal insulation properties allow the heat-absorbing sheet to suppress the temperature effect between the battery cells, and its cushioning properties (flexibility) allow the heat-absorbing sheet to act as a buffer material for a volume change due to an expansion of the battery cell, thereby easily mitigating the internal pressure rise of the secondary battery module. Furthermore, the heat-absorbing sheet can be easily made lighter and has excellent processability.

From the viewpoint of being easy to achieve suitable heat absorption properties, the content of the heat-absorbing agent in the heat-absorbing sheet is preferably in a range of 10% by mass to 95% by mass, more preferably in a range of 50% by mass to 90% by mass, and even more preferably in a range of 65% by mass to 90% by mass relative to all components of the layer including the heat-absorbing agent and the resin as a matrix.

The content of resin in the heat-absorbing sheet is preferably in a range of 5 to 90% by mass, more preferably in a range of 10 to 50% by mass, and even more preferably in a range of 10 to 35% by mass from the viewpoint of being easy to adjust the void parts and the content of the heat-absorbing agent, and increase the contents of both. Since it is easy to obtain suitable heat retaining properties and thermal insulation properties, the quantity ratio of the heat-absorbing agent to the resin is preferably 80/20 to 15/85, more preferably 70/30 to 30/70 in terms of a solid content mass ratio expressed as heat-absorbing agent/resin.

### <Heat Storage Material>

The heat-absorbing sheet may further include a heat storage material. The above-mentioned heat-absorbing agent is a substance which decomposes by absorbing heat. In contrast, the heat storage material is regarded as a substance that absorbs heat when the phase changes from solid to liquid while releasing heat when the phase changes from liquid to solid. When the heat storage material with a relatively high temperature at which the phase change occurs (in other words, melting point) is selected, the heat generated during charging the secondary battery or the like can be absorbed by the heat storage material, thereby preventing a rapid temperature rise in the secondary battery or the like, resulting in preventing a deterioration, ignition, or the like of the secondary battery. On the other hand, when the heat storage material with a relatively low temperature at which the phase change occurs is selected, the temperature of the secondary battery can be prevented from being lowered or the like by releasing heat stored by the heat storage material in a case where the temperature of the secondary battery lowers as the ambient temperature lowers.

From the viewpoint of suppressing a rapid temperature rise of the secondary battery or the like and more excellently absorbing heat generated during charging or the like, the melting point of the heat storage material is preferably 15° C. to 60° C., more preferably 20° C. to 50° C., and even more preferably 30° C. to 45° C.

The heat storage material is not particularly limited, but examples thereof include fatty acid esters and alkanes (paraffins). These compounds may be used alone or in combination of two or more kinds.

Examples of fatty acid esters include methyl myristate, methyl palmitate, ethyl palmitate, methyl stearate, and ethyl stearate. Among those, methyl palmitate, ethyl palmitate, methyl stearate, and ethyl stearate are preferred, and methyl stearate is more preferred.

Examples of alkanes include hexadecane, heptadecane, octadecane, nonadecane, icosane, henicosane, and docosane. Among those, heptadecane, octadecane, nonadecane, icosane, henicosane, and docosane are preferred, nonadecane, icosane, henicosane, and docosane are more preferred, and icosane, henicosane, and docosane are even more preferred.

Such a heat storage material is preferably in the form of coated particles coated with an outer shell made of organic materials such as melamine resins, acrylic resins, or urethane resins. In this case, an average particle size of the coated particles is not particularly limited, but is preferably 10 μm to 3,000 μm. By using the coated particles having an average particle size in such a range, it is easy to form the void parts between coated particles in the heat-absorbing sheet and to achieve excellent formability.

The average particle size is more preferably 30 μm or more, even more preferably 50 μm or more, and particularly preferably 100 μm or more. From the viewpoint of being easy to retain of the coated particles in the heat-absorbing sheet as well as a formation of suitable void parts and excellent formability, the average particle size is more preferably 2,000 μm or less, and even more preferably 1,000 μm or less. Note that the average particle size of primary particles is preferably in the above range.

The average particle size of the coated particles can be measured using a laser diffraction type particle size distribution analyzer (“LA-950V2”, manufactured by HORIBA, Ltd.) and the obtained median diameter (particle size corresponding to 50% of the cumulative volume distribution: 50% particle size) can be used.

Commercially available products may be used for such coated particles. For example, ThermoMemory FP-16, FP-25, FP-31, and FP-39 (all trade names), manufactured by Mitsubishi Paper Mills Limited, Riken Resin PMCD-15SP, 25SP, and 32SP (all trade names), manufactured by Mikiriken Industrial Co., Ltd., and the like, as those having an outer shell made of a melamine resin; Riken Resin LA-15, LA-25, and LA-32 (all trade names), manufactured by Mikiriken Industrial Co., Ltd., and the like as those having an outer shell made of silica; MicronalDS5001X and 5040X (both trade names), manufactured by BASF SE, and the like as those having an outer shell made of a polymethyl methacrylate resin; and NJ2021 and NJ2721 (both trade names) of the “CALGRIP (registered trademark)” series, manufactured by JSR Corporation, and the like as those having an outer shell made of a urethane resin.

### <Other Additives>

The heat-absorbing sheet may further include other additives, if necessary. Examples of other additives include flame retardants, adsorbents for a toxic substance such as formaldehyde, deodorants, and colored pigments.

Organic and inorganic-based flame retardants can appropriately be used as a flame retardant.

The organic-based flame retardants are, for example, preferably phosphorus compounds, halogen compounds, and guanidine compounds, and specific examples thereof include ammonium phosphate monobasic, ammonium phosphate dibasic, triester phosphate, phosphite ester, phosphonium salt, triamide phosphate, chlorinated paraffin, ammonium bromide, decabromobisphenol, tetrabromobisphenol A, tetrabromoethane, decabromodiphenyl oxide, hexabromophenyl oxide, pentabromophenyl oxide, hexabromobenzene, guanidine hydrochloride, guanidine carbonate, and guanylurea phosphate.

The inorganic-based flame retardants are preferably, for example, antimony or aluminum-containing compounds, boron compounds, or ammonium compounds, and specific examples include antimony pentoxide, antimony trioxide, sodium tetraborate decahydrate (borax), ammonium sulfate, and ammonium sulfamate.

The flame retardant may be used alone or in combination of two or more kinds.

### <Production Method of Heat-Absorbing Sheet>

The heat-absorbing sheet can be produced by preparing a composition containing the heat-absorbing agent and the resin and then molding the composition. For example, a dilute liquid in which the composition is diluted with a solvent can be applied onto a release sheet and dried, thereby molding the heat-absorbing sheet, or the resin composition may also be molded by extrusion molding, press molding, injection molding, or the like.

In a case where the resin composition is blended with a relatively large amount of the heat-absorbing agent (for example, in a case where the content of the heat-absorbing agent is 50% by mass or more on a basis of the total amount of the resin composition), it is preferable to use the resin composition diluted with a solvent from the viewpoint of obtaining the heat-absorbing sheet having excellent dispersion of the heat-absorbing agent.

The solvents used to dilute the resin composition are not particularly limited, and examples thereof include aliphatic or aromatic hydrocarbons such as pentane, hexane, cyclohexane, and toluene; esters such as ethyl acetate and n-butyl acetate; ketones such as acetone and methyl ethyl ketone; alcohols such as ethanol, isopropanol, butanol, ethylcarbitol, ethylcellosolve, and butylcellosolve; and water.

The dilution liquid of the resin composition is usually in the form of a slurry in which the resin is dissolved by the solvent and the heat-absorbing agent is dispersed in the solvent. For example, the solvent and heat-absorbing agent are stirred in a dispersion mixer such as a bead mill to make a dispersion liquid, and then the resin solution previously dissolved in the solvent is added to such a dispersion liquid and the obtained mixture is further stirred in the above dispersion mixer to make a dilution liquid of the resin composition.

The content of the heat-absorbing agent in the resin composition may be blended so that the amount ratio of heat-absorbing agent/resin in the heat-absorbing sheet is in the above range.

The dilution liquid of the resin composition may also be a mixture of the heat-absorbing agent and the above-mentioned emulsion resin. Examples of the solvent configuring such an emulsion resin suitably includes water or an aqueous medium which is a mixture of water and a water-soluble solvent. Here, examples of the water-soluble solvents include alcohols such as methanol, ethanol, isopropanol, ethylcarbitol, ethyl cellosolve, and butyl cellosolve, and polar solvents such as N-methylpyrrolidone.

Note that the solid content concentration in the resin composition diluted with a solvent is, for example, 30 to 70% by mass, preferably 35 to 65% by mass, more preferably 40 to 60% by mass.

The content of resin in the resin composition, for example, in a case of using an acrylic-based emulsion resin, is preferably 30 to 200 parts by mass, and more preferably 50 to 150 parts by mass relative to 100 parts by mass of an aqueous medium. In this case, it is easy to adjust the viscosity of the resin composition to a suitable range and also easy to foam stably.

The heat-absorbing sheet having the void parts which are equipped in a preferred embodiment of the secondary battery module of the present invention, can be made by a method including mechanical or chemical foaming.

The heat-absorbing sheet having the void parts can preferably be made by mechanically foaming the resin composition including the heat-absorbing agent and the above-mentioned emulsion resin, followed by coating or casting, and drying. When making the heat-absorbing sheet, the resin composition may be dried and then cured by heat, ultraviolet light, or the like, if necessary.

On the other hand, examples of a production method of the heat-absorbing sheet by chemical foaming includes a method in which the above resin composition further including a heat decomposable-type foaming agent or a foaming aid is fed to an extruder, melted and kneaded, and extruded into a sheet form to obtain a sheet, and then the heat decomposable-type foaming agent in the sheet is foamed. Examples of the heat decomposable-type foaming agents include azodicarbonamide, N,N′-dinitrosopentamethylenetetramine, and p-toluenesulfonyl semicarbazide, and the heat decomposable-type foaming agent may be used alone or in combination of two or more kinds. From the viewpoint of ease adjustment of the foaming ratio, tensile strength, compression recovery ratio, and the like to the desired range, the amount of the heat decomposable-type foaming agent added is usually preferably 1 part by mass to 40 parts by mass, and more preferably 1 part by mass to 30 parts by mass relative to 100 parts by mass of the resin. In addition, the method of foaming the heat decomposable-type foaming agent in the sheet is not particularly limited and examples thereof include a method of heating with hot air, infrared rays, a salt bath, or an oil bath.

When making the heat-absorbing sheet having the void parts, the resin composition may be mixed with surfactants, thickeners, flame retardants, cross-linking agents, or the like, if necessary.

For example, in order to refine and stabilize the foamed foam, a surfactant can be mixed with the resin composition. Any anionic, cationic, nonionic, amphoteric surfactants, or the like may be used as a surfactant.

In particular, from the viewpoint of enhancing the stability of the foamed foam, the anionic surfactants are preferred as a surfactant, and fatty acid ammonium surfactants such as ammonium stearate are more preferred. The surfactant may be used alone or in combination of two or more kinds.

In a case where the surfactant is mixed in the resin composition, its content is preferably 30 parts by mass or less, more preferably 0.5 to 20 parts by mass, and even more preferably 3 to 15 parts by mass relative to 100 parts by mass (solid content) of the resin, since it is easy to obtain suitable foaming properties.

A thickener can be mixed to improve the stability and film formability of the foamed foam. Examples of the thickeners include acrylic acid-based thickeners, urethane-based thickeners, and polyvinyl alcohol-based thickeners. Among those, acrylic acid-based thickeners and urethane-based thickeners are preferred. In a case where the thickener is mixed with the resin composition, its content is preferably 0.1 to 10 parts by mass, and more preferably 0.5 to 8 parts by mass relative to 100 parts by mass (solid content) of the resin.

From the viewpoint of improving the mechanical strength of the heat-absorbing sheet, a curing agent may also be mixed with the resin composition. The curing agent can appropriately be selected according to the kind of the resin used, and examples thereof include epoxy-based curing agents, melamine-based curing agents, isocyanate-based curing agents, carbodiimide-based curing agents, and oxazoline-based curing agents.

### <Physical Properties of Heat-Absorbing Sheet>

The heat-absorbing sheet preferably has a thickness of 100 μm to 20,000 μm, more preferably 100 μm to 6,000 μm, further preferably 100 μm to 3,000 μm, and even more preferably 100 μm to 1,000 μm. In this case, cushioning properties, dynamic strength, and handling properties such as processability, of the foam sheet can be further improved.

The heat-absorbing sheet preferably has a mandrel diameter, where cracking occurs, of 25 mm or less, more preferably 20 mm or less, and even more preferably 16 mm or less in a bending resistance test in accordance with JIS K5600-5-1 (1999). The heat-absorbing sheet that meets such requirements can ensure suitable flexibility and excellent follow-up properties to the surface of various members.

Also, the heat-absorbing sheet preferably has a stiffness, measured in accordance with the Gurley method specified in JIS L1913 (2010), of 0.1 to 30 mN, more preferably 0.5 to 20 mN, and even more preferably 1 to 10 mN. The heat-absorbing sheets having such stiffness can also ensure suitable flexibility and excellent follow-up properties to the surface of various members.

The heat-absorbing sheet preferably has a tensile strength of 0.1 MPa or more, and more preferably 0.2 MPa or more. In this case, the heat-absorbing sheet that has flexibility yet is tough, can be obtained. Such a heat-absorbing sheet is also preferred because the heat-absorbing sheet hardly causes cracking during processing, transportation, or the like, and can exhibit suitable processability, handling, transportation suitability, bending suitability, and the like.

Note that the upper limit of the tensile strength of the heat-absorbing sheet is not particularly limited, but is preferably 15 MPa or less, more preferably 10 MPa or less, and even more preferably 5 MPa or less.

In addition, the heat-absorbing sheet has an elongation at tensile break of preferably 5% or more, more preferably 30% or more, and even more preferably 50% or more. In this case, the embrittlement of the heat-absorbing sheet 20 can be suppressed. Such a heat-absorbing sheet also hardly causes cracking and chipping even if bending or distortion occurs during processing, transportation, or the like.

Note that the upper limit of an elongation at tensile break of the heat-absorbing sheet is preferably 1,000% or less, more preferably 500% or less, and even more preferably 300% or less. In this case, the heat-absorbing sheet can achieve excellent flexibility while being tough. Therefore, the heat-absorbing sheet is easy to obtain excellent processability, handling, transportation suitability, follow-up properties to the surface of various members, and the like.

The tensile strength and the elongation at tensile break of the heat-absorbing sheet can be measured according to the method specified in JIS K6251. Specifically, the heat-absorbing sheet is cut into a dumbbell-like No. 2 shape, and a test specimen with two marked lines is made with an initial distance between the marked lines of 20 mm. The test specimen is mounted on a tensile testing machine and pulled at a speed of 200 mm/min to break. At this time, the maximum force (N) to break and the distance (mm) between the marked lines at break are measured, and the tensile strength and the elongation at tensile break can be calculated using the following equation.

The tensile strength Is (MPa) is calculated by the following equation.

$${T}_{S} = {F}_{m} / Wt$$

Fₘ is a maximum force (N), W is a width of a parallel part (mm), and t is a thickness of a parallel part (mm).

In addition, the elongation at tensile break, E_{b} (%), is calculated by the following equation.

$${E}_{b} = ( {L}_{b} - {L}_{0} ) / {L}_{0} \times 100$$

L_{b} is a distance between marked lines at break (mm) and L₀ is an initial distance between marked lines (mm).

### [Adhesive Layer]

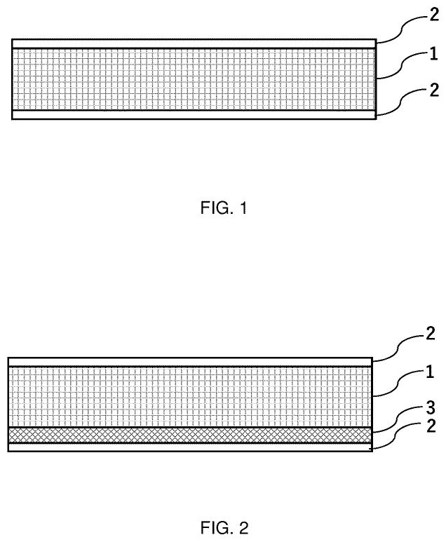

From the viewpoint of further improving the adhesive between each battery cell in the secondary battery module of the present invention, for example, as shown in FIG. 1, the heat-absorbing sheet may be a laminate having further adhesion layers on outermost layers on both sides thereof. In other words, an aspect in which, in the secondary battery module of the present invention, a plurality of battery cells are fixed by the adhesive layer further included in the heat-absorbing sheet, may be employed.

Examples of the adhesive agents that can form the adhesive layer include those including resins such as natural rubbers, synthetic rubbers, acrylic-based resins, silicone-based resins, urethane-based resins, and vinyl ether-based resins as a binder. The form of such an adhesive agent may be any of solvent-based, emulsion type, water-based, hot-melt type, or solvent-free type that cures with active energy rays such as ultraviolet rays and electron beams.

In a case where the heat-absorbing sheet has adhesive layers on the outermost layers of the surfaces of both sides of the sheet, each adhesive layer may have the same adhesive strength or different adhesive strength. Specifically, one of the adhesive layers may be a so-called strong adhesive agent layer and the other may be a weak adhesive agent layer. In addition, the respective adhesive layers may have the same or different compositions. In consideration of the disassembly of the secondary battery module, the adhesive strength of the adhesive layer can also be designed.

The adhesive agent that can form the adhesive layer preferably includes a solvent from the viewpoint of maintaining excellent coating workability or the like. For example, toluene, xylene, ethyl acetate, butyl acetate, acetone, methyl ethyl ketone, hexane, and the like can be used as the solvent. In addition, in the case of using a water-based adhesive agent composition, water or aqueous solvents principally consisting of water can be used.

The adhesive agents that can form the adhesive layer may include tackifier resins, cross-linking agents, other additives, or the like, if necessary.

Examples of the tackifier resins include various tackifier resins of rosin-based, polymerized rosin-based, polymerized rosin ester-based, rosin phenol-based, stabilized rosin ester-based, disproportionated rosin ester-based, terpene-based, terpene phenolic-based, petroleum based, or the like.

Examples of the cross-linking agents include well-known cross-linking agents of isocyanate-based, epoxy-based, aziridine-based, polyvalent metal salt-based, metal chelate-based, keto-hydrazide-based oxazoline-based, carbodiimide-based, silane-based, glycidyl(alkoxy) epoxysilane-based, or the like, and the cross-linking agents can be used for the purpose to improve the cohesive strength of the adhesive agent layer (B).

Examples of other additives include well-known foaming agents, plasticizers, softeners, antioxidants, fillers such as glass and plastic fibers, balloons, beads, and metal powders, colorants such as pigments and dyes, pH adjusters, film-forming aids, leveling agents, thickening agents, water repellents, and defoaming agents. These other additives can be added within a range that does not impart the desired effect of the present invention.

The adhesive layer preferably has a thickness of 10 μm or less, and more preferably in a range of 1 μm to 5 μm. Note that the adhesive layer may include the above-mentioned heat-absorbing agent.

### [Flame Shielding Layer]

The heat-absorbing sheet may be a laminate further having a flame shielding layer. When the heat-absorbing sheet has the flame shielding layer, it is effective in preventing or delaying the spread of fire to other battery cells by blocking flames even when a secondary battery ignites due to a rapid heat generation or temperature rise. Note that, in a case where the heat-absorbing sheet further has both the above-mentioned adhesive layer and the flame shielding layer, the flame shielding layer is provided inside the adhesive layer.

As the flame shielding layer, an inorganic fiber sheet made of a woven fabric, a non-woven fabric, a sheeted product, or the like of inorganic fibers and noncombustible paper can be suitably used. The flame shielding layer can be provided by laminating an inorganic fiber sheet on one surface of the heat-absorbing sheet, as shown in FIG. 2, for example.

Specific examples of the inorganic fiber sheet that can be applied to the flame shielding layer include a glass cloth made of glass wool, rock wool, glass fibers, or the like. The inorganic fiber sheet may be used alone or in combination of two or more kinds.

Specific examples of noncombustible paper applicable to the flame shielding layer include paper that is applied with, impregnated with, or internally added with a flame retardant to impart self-extinguishing properties and thereby suppressing the spread of flames. Here, examples of the flame retardants include metal oxides such as magnesium hydroxide and aluminum hydroxide, basic compounds such as phosphates, borates, and stefamates, and glass fibers.

The thickness of the flame shielding layer is not particularly limited, and for example, can appropriately be set in a range of 10 to 1,000 μm. In addition, the weight per unit area of the inorganic fiber sheet as the flame shielding layer is preferably 1 to 1,000 mg/cm².

### [Thermal Conductive Layer]

As for the heat-absorbing sheet, it is preferable to use one having a thermal conductive layer on one or both sides thereof, because even when the temperature of the battery cell or the like rises (for example, in a case of reaching 800° C.), the heat is transferred in the surface direction by the thermal conductive layer having high thermal conductivity and the heat-absorbing agent efficiently absorbs heat, thereby being able to more effectively suppress the temperature rise on its surface, resulting in more effective prevention of ignition or damage due to thermal runaway of the secondary battery. Furthermore, in a case where the thermal conductive layer is metal foil such as aluminum foil, an effect of reflecting radiant heat can also be obtained, and the transfer of heat generated by thermal runaway can be further delayed.

As the thermal conductive layer, for example, metal foil (metal layer) such as aluminum foil, copper foil, and iron foil, a graphite sheet, or the like is preferably used, and metal foil such as aluminum foil is particularly preferably used, because even when the temperature of the battery cell or the like rises, temperature rise on its surface can be more effectively suppressed, resulting in more effective prevention of ignition or damage due to thermal runaway of the secondary battery. Furthermore, in a case where the metal layer is used as the thermal conductive layer, a deformation of the heat-absorbing sheet can be suppressed and flame shielding properties can also be provided, which is therefore particularly preferable.

In addition, as the thermal conductive layer, one in which multiple materials are laminated, can also be used. Specifically, it is preferable to use a laminate of the metal layer and a fiber material (fiber sheet) that can provide adhesion to the metal layer. As for the thermal conductive layer, more specifically, it is preferable to use a laminate of aluminum foil and a paper material in order to enhance adhesion between the thermal conductive layer and the heat-absorbing sheet. Examples of the method of laminating the aluminum foil and paper material include a method of laminating the aluminum foil and paper material with a polyethylene sheet or the like.

It is preferable to use a thermal conductive layer having a thickness of 5 μm to 200 μm, and it is preferable to use a thermal conductive layer having a thickness of 5 μm to 50 μm in order to achieve both the above effects and making secondary battery module thinner, lighter, or the like.

The lower limit value of the thermal conductivity of the thermal conductive layer is preferably 0.045 W/m·K or higher, and more preferably 1 W/m·K or higher. In addition, the upper limit value of the thermal conductivity of the thermal conductive layer is preferably 1,800 W/m·K or less, and more preferably 500 W/m. K or less.

In a case where the heat-absorbing sheet is a laminate that, in addition to the layer including the heat-absorbing agent and the resin as a matrix, is further provided with a layer having any other configuration, such as an adhesive layer, a flame shielding layer, a thermal conductive layer, or adhesion layers, there are no particular limitations on the production method of such a laminate. For example, the laminate can be produced through a method of coating the above-mentioned adhesive agent on the surface of a release sheet and forming the adhesive layer by drying or the like, and transferring the adhesive layers to both surfaces of the heat-absorbing sheet; a step of overlaying the flame shielding layer on one surface of the heat-absorbing sheet with an adhesion agent layer interposed therebetween, if necessary, and transferring the pre-made adhesive layers to the other surface of the heat-absorbing sheet and the surface of the flame shielding layer; and a step of foam molding by coating and heating the resin including a heat-absorbing material on the flame shielding layer. Such a laminate can also be produced by directly coating and drying the above-mentioned adhesive agent on both surfaces of the heat-absorbing sheet to form the adhesive layer.

Note that examples of the adhesion agent that can form the above-mentioned adhesion agent layer include urethane resin-based adhesion agents, acrylic resin-based adhesion agents, and polyester resin-based adhesion agents.

A preferred embodiment of the heat-absorbing sheet, specifically, includes a heat-absorbing sheet that includes the heat-absorbing agent represented by the calcium sulfate dihydrate (gypsum) and sodium hydrogen carbonate (sodium bicarbonate), has the voids, and has the thermal conductive layer represented by the aluminum foil.

The secondary battery may be ignited or damaged caused by thermal runaway (that is, a state where a temperature of the battery cell configuring the secondary battery can be uncontrolled). The risk of an occurrence of thermal runaway increases when the temperature of the battery cell exceeds about 80° C., furthermore, when the temperature reaches around 160° C., the separator in the battery cell melts down and the temperature rises rapidly, making it difficult to suppress thermal runaway.

Therefore, the heat-absorbing sheet is required to achieve (1) stopping thermal runaway by absorbing heat before the temperature of the battery cell reaches 160° C., or extending the time until the temperature reaches 160° C. as long as possible (suppressing the temperature rise of the battery cell), and (2) suppressing an occurrence of thermal runaway of multiple battery cells by transferring heat from the battery cell that has reached a high temperature to other adjacent battery cells.

The heat-absorbing sheet including the heat-absorbing agent represented by the calcium sulfate dihydrate (gypsum) and sodium hydrogen carbonate (sodium bicarbonate) can achieve the effects shown in (1) and (2) above even when the temperature of the battery cell or the like rises in a short time (for example, in a case of reaching 800° C. in a few seconds). As a result, ignition and damage due to thermal runaway of the secondary battery can be suppressed more effectively.

The heat-absorbing sheet having the thermal conductive layer including aluminum foil can also achieve the effects shown in (1) and (2) above. As a result, ignition and damage due to thermal runaway of the secondary battery can be suppressed more effectively.

In addition, as for the heat-absorbing sheet having the voids (pores), its thermal insulation properties allow the heat-absorbing sheet to suppress the temperature effect between the battery cells, and its cushioning properties (flexibility) allow the heat-absorbing sheet to act as a buffer material for a volume change due to an expansion of the battery cell, thereby being able to mitigate the internal pressure rise of the secondary battery module.

On the other hand, in a case where further thinning and miniaturizing of the secondary battery module are required, it is preferable to use the heat-absorbing sheet that does not have the voids as the heat-absorbing sheet. Specific examples of the heat-absorbing sheets include a heat-absorbing sheet that includes a heat-absorbing agent represented by the calcium sulfate dihydrate (gypsum) and sodium hydrogen carbonate (sodium bicarbonate) and has the metal layer represented by the aluminum foil, but has no voids. The heat-absorbing sheet preferably has a thickness of 100 μm to 10,000 μm, and more preferably 100 μm to 3,000 μm.

### [Secondary Battery Module]

The kind of secondary battery is not particularly limited, and examples thereof include lithium-ion batteries, lithium-ion polymer batteries, lead storage batteries, nickel-hydrogen storage batteries, nickel-cadmium storage batteries, nickel-iron storage batteries, nickel-zinc storage batteries, silver oxide-zinc storage batteries, metal air batteries, polyvalent cation batteries, and capacitors. Among those, the suitable application targets are lithium-ion batteries.

The secondary battery module of the present invention is a secondary battery to be installed, for example, in a vehicle or the like, and has a plurality of battery cells and a case for storing such battery cells.

The battery cell configuring the secondary battery module may be, for example, a battery cell in which an exterior film for a battery is used as an exterior material, and in the exterior material, a battery element provided with at least a positive electrode material, a negative electrode material, a separator, a positive electrode terminal, a negative electrode terminal, or the like is enclosed.

The exterior material is usually formed by subjecting the sealant layers of the exterior film for a battery to heat-sealing to each other, and has a flange part (an area where the sealant layers are adhered to each other by heat-sealing) at the periphery. In addition, the positive and negative electrode terminals connected to each of the positive and negative electrode materials usually protrude outward from the flange part.

In the secondary battery module of the present invention, the above-mentioned heat-absorbing sheet is sandwiched between adjacent battery cells housed in a case. The case can be made of, for example, aluminum, iron, or a metal material including these, or a resin material such as polyphenylene sulfide, and when the case is made of a resin material, it can contribute to lightening of the secondary battery module.

The heat-absorbing sheet can be sandwiched between the battery cells by, for example, adhesion agents, fusion (ultrasonic fusion, high-frequency fusion, and thermal fusion), adhesive agents, or the like. Here, in a case where the heat-absorbing sheet is a laminate further having the adhesive layer, it is advantageous from the viewpoint of workability when making a module because further use of adhesion agents and adhesive agents can be omitted.

Such a configuration allows the heat-absorbing sheet sandwiched between the battery cells to absorb the heat generated during charging the secondary battery, or the like, resulting in suppressing the rapid temperature rise of the battery cells, or the like, and preventing deterioration, ignition, or the like of the battery cell, previously. In addition, when the heat-absorbing sheet having the voids is sandwiched between the battery cells, its thermal insulation properties allow the heat-absorbing sheet to suppress the temperature effect between the battery cells, and its cushioning properties (flexibility) allow the heat-absorbing sheet to act as a buffer material for a volume change due to an expansion of the battery cell, thereby easily mitigating the internal pressure rise of the secondary battery module.

### EXAMPLES

Hereinafter, the present invention will be specifically described with reference to Examples. However, the present invention is not limited only to the following Examples. The compounds used in the present Examples and others are listed below.

### <Resin>

Resin 1: “VONCOAT 5400EF” (product name, water-dispersed acrylic resin emulsion, 50% non-volatile content, manufactured by DIC Corporation)
Resin 2: “CN Paste 1805” (product name, vinyl chloride-based resin paste, manufactured by DIC Kitanihon Polymer Corporation)

### <Foam Stabilizer>

Foam stabilizer 1: “DICNAL M-40” (product name, sulfonic acid type anionic surfactant, manufactured by DIC Corporation)

### <Cross-Linking Agent>

Cross-linking agent 1: “DICNAL GX” (product name, oxazoline group-containing polymer, manufactured by DIC Corporation)

### <Heat-Absorbing Agent>

Aluminum hydroxide: (product name: “Aluminum Hydroxide, Extra pure”, manufactured by Kanto Chemical Co., Inc.)
Calcium sulfate dihydrate: (product name: “Calcium Sulfate Dihydrate, Guaranteed Reagent”, manufactured by Kanto Chemical Co., Inc.)
Sodium hydrogen carbonate: (Product name: “Sodium Hydrogen Carbonate, Guaranteed Reagent”, manufactured by Kanto Chemical Co., Inc.)

### <Heat Storage Agent>

Heat storage agent 1: “ART PEARL NJ38815” (Product name: Heat storage capsule particles consisting of fatty acid esters coated with an outer shell made of urethane-based resin, manufactured by Negami Chemical Industrial Co., Ltd.)

### 1. Production of Heat-Absorbing Sheet

### Production Example 1

100 parts by mass of a resin 1 (water-dispersed acrylic resin emulsion), 6 parts by mass of a foam stabilizer 1 (sulfonic acid type anionic surfactant), and 3 parts by mass of a cross-linking agent 1 (oxazoline group-containing polymer) were blended, and the mixture was stirred and mixed (2,000 rpm, 3 minutes) by a disperser to prepare a binder for mechanical foaming. The prepared binder was stirred and foamed so that the foaming ratio became double, and 240 parts by mass of aluminum hydroxide as a heat-absorbing agent was blended thereto, and stirring was continued for another 5 minutes to obtain a foamable mixture.

The resulting foamable mixture was applied on polyethylene terephthalate (PET) film with an applicator. The applied material was heated at 105° C. for 5 minutes as pre-drying and then heated at 120° C. for 3 minutes, and the sheet-like material from which the polyethylene terephthalate film was removed, was then turned over and cured by further subjecting to a heat treatment at 120° C. for 3 minutes to produce a heat-absorbing sheet 1 having a thickness of 1 mm.

The specific gravity of the heat-absorbing sheet 1 was 0.64, the mass was 640 g/m², and the mass of the heat-absorbing agent in the heat-absorbing sheet 1 was 514 g/m². The cross section obtained by cutting the heat-absorbing sheet 1 was checked using an electron microscope (Digital Microscope VHX-900, manufactured by Keyence corporation).

### Production Examples 2 to 5

A heat-absorbing sheets 2 to 5 were produced in the same manner as in Production Example 1, except that the kind and blending amount of the resin 1, the foam stabilizer 1, the cross-linking agent 1, and the heat-absorbing agent were as listed in Table 1.

### Production Example 6

100 parts by mass of a resin 2 (vinyl chloride-based resin paste) and 120 parts by mass of aluminum hydroxide as a heat-absorbing agent were mixed to prepare a plastisol coating liquid, and this plastisol coating liquid was applied onto a PET film with an applicator. The applied material was heated at 100° C. for 5 minutes as pre-drying, then subjected to a heat treatment at 140° C. for 10 minutes to cure, and the PET film was removed to produce a heat-absorbing sheet 6 having a thickness of 1 mm.

### Production Example 7

A heat-absorbing sheet 7 was produced in the same manner as in production Example 6, except that the heat-absorbing agent and further a heat storage agent 1 were blended as listed in Table 1.

### Production Example 8

A sheet 1 was produced in the same manner as in Production Example 1, except that no heat-absorbing agent was blended.

### Production Example 9

A sheet 2 was produced in the same manner as in Production Example 6, except that no heat-absorbing agent was blended.

### Production Example 10

A sheet 3 was produced in the same manner as in Production Example 6, except that the kind and blending amount of the resin 2 and the heat-absorbing agent were as listed in Table 1.

### Production Example 11

A sheet 4 was produced in the same manner as in Production Example 6, except that the heat storage agent 1 was blended as listed in Table 1, without blending the heat-absorbing agent.

### Production Example 12

A heat-absorbing sheet 8 was obtained in the same manner as in Production Example 1, except that a glass cloth (thickness of 140 μm) was used instead of the PET film and the process of removing the PET film and the glass cloth was not performed.

### Production Example 13

Instead of the heat-absorbing sheet, a sheet material of polyolefin foam (TORAYPEF, product number 300050 AG00, thermal conductivity of 0.035 W/m·K, manufactured by TORAY INDUSTRIES, INC.) was prepared as a thermal insulation material 1.

### Production Example 14

Instead of the heat-absorbing sheet, a sheet material configured with aerosilica gel and glass fiber (Super Light Silica Aerogel, manufactured by Xiaomei, sound insulation cotton hydrophobic mat material, thermal conductivity of 0.012 to 0.018 W/m·K) was prepared as a thermal insulation material 2.

### Production Example 15

A heat-absorbing sheet 9 was obtained in the same manner as in Production Example 1, except that a composite sheet of aluminum foil and a paper material (ML sheet, manufactured by DIC Decor, Inc.) was used instead of the glass cloth (thickness of 140 μm).

### Example 1

The heat-absorbing sheet 1 obtained in Production Example 1 was sandwiched between the battery cells to create a secondary battery module.

### Examples 2 to 9, Comparative Examples 1 to 4

The secondary battery modules were created in the same manner as in Example 1, using the heat-absorbing sheets 2 to 9, the sheets 1 to 4, and the thermal insulation materials 1 and 2 obtained in the Production Examples.

### 2. Evaluation of Heat-Absorbing Sheet, Sheet and Thermal Insulation Material

### 2-1. Formability

Under conditions at 23° C. in the atmosphere, each sheet was wrapped around a rod having a diameter of 10 mm and the presence or absence of cracks on the surface of the heat-absorbing sheet, the sheet, and the thermal insulation material was visually checked.

### [Evaluation Criteria]

A: No cracks were observed
C: Cracks have occurred.

### 2-2-1. Heat Absorption Characteristics 1

The heat absorption starting temperature and heat absorption peak temperature were measured for the heat-absorbing sheet as follows. The temperature was increased from 0° C. to 350° C. at 1° C./min under a nitrogen atmosphere using a differential scanning calorimetry analyzer (DSC; DSC-7020, manufactured by Hitachi High-Tech Corporation), and at this time, the temperature in which a rise of the melting peak starts from the baseline of the DSC measurement curve was adopted as a heat absorption starting temperature (° C.), and the point of maximum difference from the baseline of the DSC measurement curve was adopted as a heat absorption peak temperature (° C.). In addition, the value in which the integral value of the heat absorption peak on a basis of the baseline of the DSC measurement curve was divided by the mass of the heat-absorbing agent used in the measurement was adopted as a heat absorption amount (J/g).

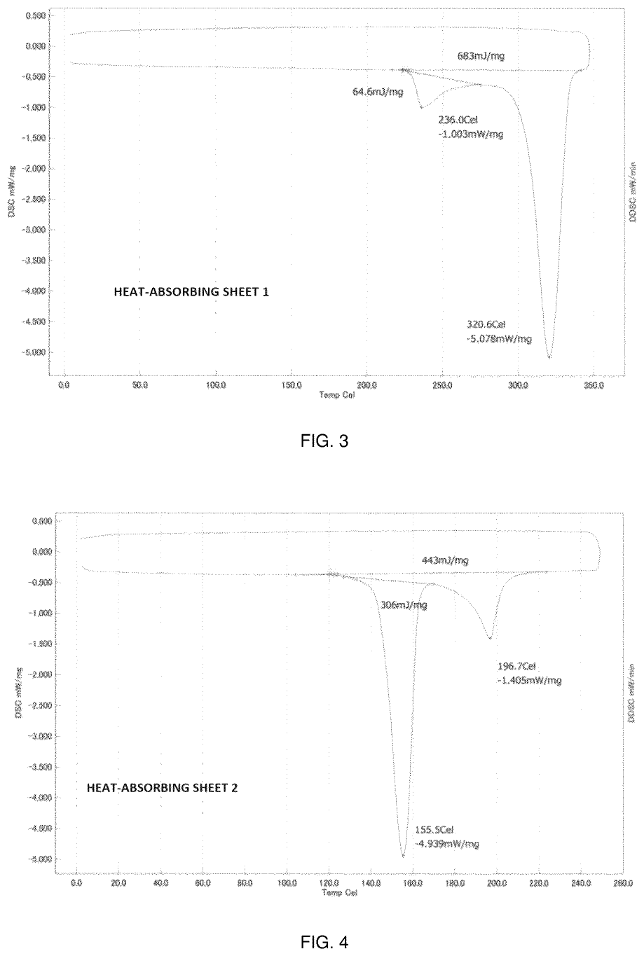

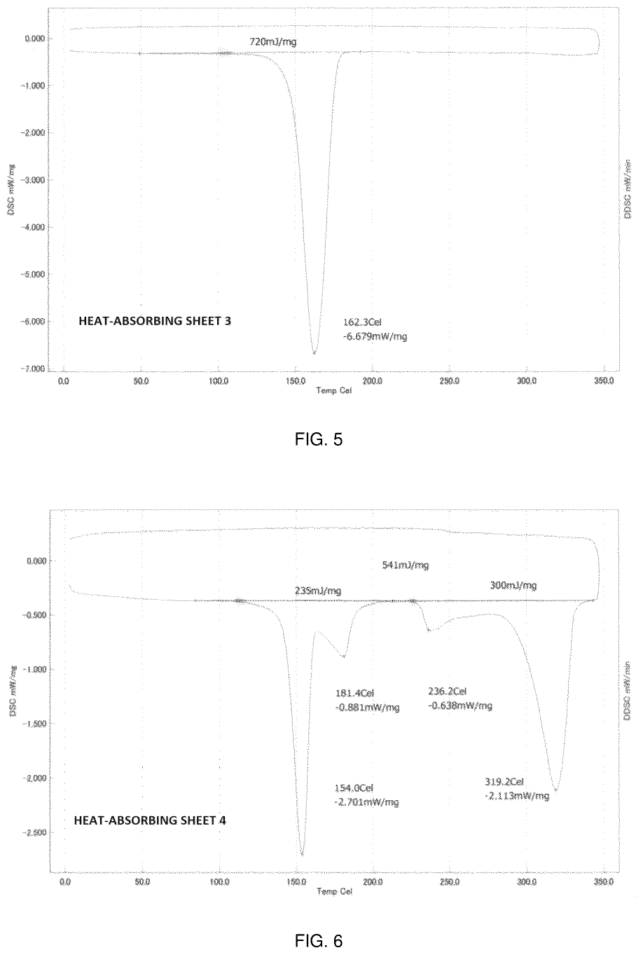

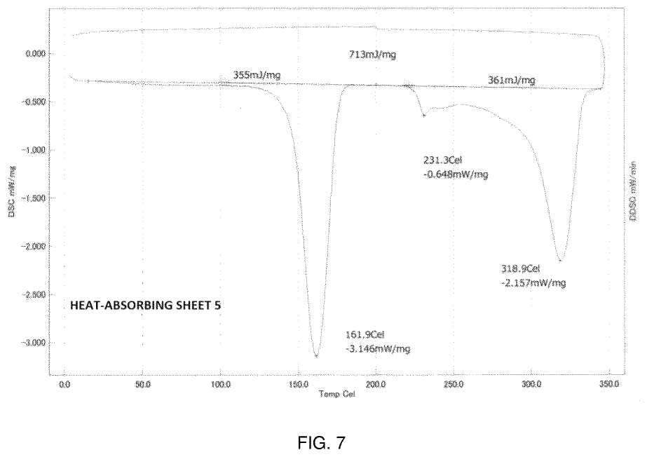

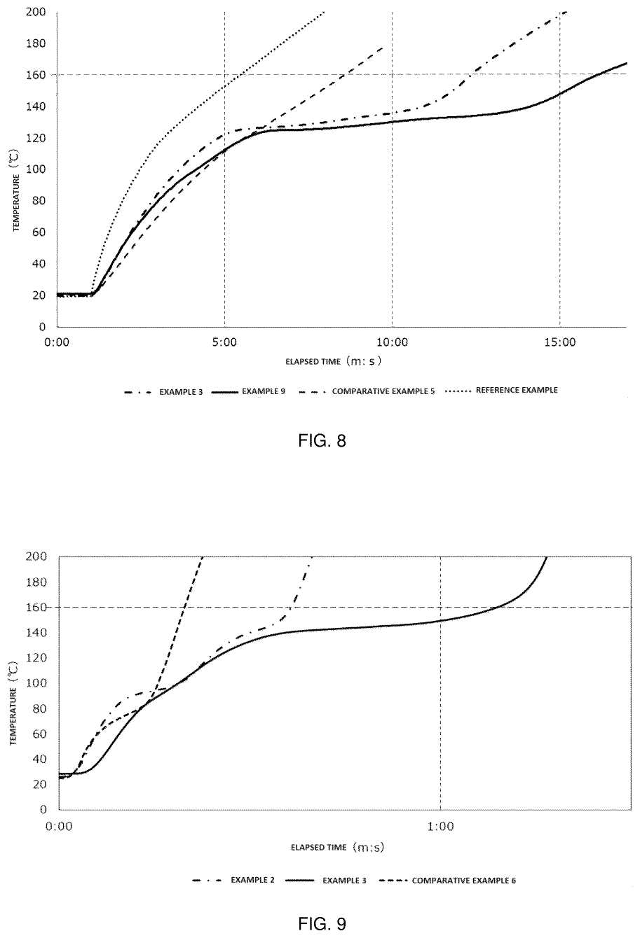

The DSC curves for each sheet are also shown in FIGS. 3 to 7.

### 2-2-2. Heat absorption characteristics 2

A rectangular heat-generating heater (30 W), manufactured by Hakko Electric Co., Ltd., having a length of 100 mm×a width of 50 mm×a thicknesses of 1.5 mm, was prepared and used as a substitute for the secondary battery cell that generated heat to evaluate the heat absorption characteristics 2 by the following method.

First, the heat-absorbing sheets or the sheets having a length of 80 mm×a width of 50 mm×a thicknesses listed in Table 2, obtained in Example 3, Example 9, or Comparative Example 5, were overlaid on one surface of the heat-generating heater and the resultants were sandwiched and fixed between two square pieces of wood having a length of 150 mm×a width of 150 mm×a thickness of 21 mm.

Next, the heat-generating heater was made to generate heat at a constant amount of heat of 30 W, the time taken for the temperature T between the heat-absorbing sheet and the wood in contact with the heat-absorbing sheet to reach 160° C. was measured, and the heat absorption characteristics 2 were evaluated based on that time. The temperature T was the measurement point corresponding to the surface temperature of a cell placed next to the cell that generated heat through the heat-absorbing sheet or the like.

Note that the results of the evaluation without using the heat-absorbing sheet in the above test are used as reference examples.

### 2-2-3. Heat absorption characteristics 3

Using a cone calorimeter (manufactured by Toyo Seisaku-sho, Ltd), the heat absorption characteristics 3 of the heat-absorbing sheet were evaluated by the following method. The test method was performed in accordance with the appendix of JIS A 5430, and thermocouples were attached to the opposite surfaces of heated sides of the test pieces of Examples and Comparative Examples, and the temperature changes were measured to evaluate the thermal effects through the test pieces.

First, the thermocouple was attached to the bottom surface of the heat-absorbing sheets or the sheets prepared in Example 2, Example 3, and Comparative Example 6, the side surface and the bottom surface thereof were wrapped with aluminum foil, placed in a holding frame, and an inorganic fiber was then filled in the back surface side before being pressed into a test piece holder. The test piece holder was placed in the cone calorimeter and irradiated with 50 kW/m² of radiant heat from a radiant heat electric heater to the test piece surface. Note that when the temperature of the radiant heat electric heater was measured, the temperature was 800° C. to 850° C.

The temperature of the heated side and the opposite side of the heat-absorbing sheet, the thermal insulation material, or the sheet prepared in the above Examples and Comparative Examples was measured, the time taken for the temperature to reach 160° C. was measured, and the heat absorption characteristics 3 were evaluated based on that time.

### 2-3. Flammability

Each sheet was placed on a wire mesh and held for 15 seconds under conditions at 23° C. in the atmosphere while approaching a lighter flame from the bottom part of the wire mesh so that the tip of the flame slightly touched the surface of the sheet, and flammability was evaluated according to the following criteria.

### [Evaluation Criteria]

A: Sheet is not ignited
B: Sheet is ignited, but quickly extinguishes itself
C: Sheet is burned

The results of the above evaluation are also listed in Table 1.

TABLE 1

| | | | | | | | | | | | | Comp. | Comp. | Comp. | Comp. |
|---|---|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | Ex. 1 | Ex. 2 | Ex. 3 | Ex. 4 |
| Sheet No. | | | Heat- | Heat- | Heat- | Heat- | Heat- | Heat- | Heat- | Heat- | Heat- | Sheet | Sheet | Sheet | Sheet |
| | | | absorbing | absorbing | absorbing | absorbing | absorbing | absorbing | absorbing | absorbing | absorbing | 1 | 2 | 3 | 4 |
| | | | sheet 1 | sheet 2 | sheet 3 | sheet 4 | sheet 5 | sheet 6 | sheet 7 | sheet 8 | sheet 9 | | | | |
| Components | Resin 1 | Water-dispersed | 100 | 100 | 100 | 100 | 100 | | | 100 | 100 | 100 | | | |
| | | acrylic resin emulsion | | | | | | | | | | | | | |
| | Resin 2 | Vinyl chloride paste | | | | | | 100 | 100 | | | | 100 | 100 | 100 |
| | | (1805) | | | | | | | | | | | | | |
| | Foam stabilizer 1 | DICNAL M-40 | 6 | 6 | 6 | 6 | 6 | | | 6 | 6 | 6 | | | |
| | Cross-linking | DICNAL GX | 3 | 3 | 3 | 3 | 3 | | | 3 | 3 | 3 | | | |
| | agent 1 | | | | | | | | | | | | | | |
| | Heat-absorbing | Aluminum hydroxide | 240 | | | 70 | 200 | 120 | 70 | | | | | | |
| | agent | Calcium sulfate | | 110 | | 70 | | | | | | | | 120 | |
| | | dihydrate | | | | | | | | | | | | | |
| | | Sodium hydrogen | | | 450 | | 200 | | | 450 | 450 | | | | |
| | | carbonate | | | | | | | | | | | | | |
| | Heat storage | NJ2021 | | | | | | | 60 | | | | | | 55 |
| | material 1 | | | | | | | | | | | | | | |
| | Flame shielding | Glass cloth | | | | | | | | Use | | | | | |
| | layer | | | | | | | | | | | | | | |
| | Thermal | Aluminum foil | | | | | | | | | Use | | | | |
| | conductive layer | (paper composite) | | | | | | | | | | | | | |
| Characteristics | Heat absorption | Heat absorption | 230 | 120 | 100 | 120 | 100 | 230 | 10 | 100 | 100 | | | | 10 |
| | characteristics 1 | starting temperature | | | | | | | | | | | | | |
| | Characteristics | 1 (° C.) | | | | | | | | | | | | | |
| | of heat-absorbing | Heat absorption peak | 320 | 156 | 162 | 156 | 162 | 320 | 25 | 162 | 162 | | | | 25 |
| | sheet (DSC) | temperature 1 (° C.) | | | | | | | | | | | | | |
| | | Heat absorption | 683 | 443 | 720 | 235 | 355 | 456 | 48 | 720 | 720 | | | | 65 |
| | | amount 1 (J/g) | | | | | | | | | | | | | |
| | | Heat absorption | | | | 230 | 230 | | 230 | | | | | | |
| | | starting temperature | | | | | | | | | | | | | |
| | | 2 (° C.) | | | | | | | | | | | | | |
| | | Heat absorption peak | | | | 320 | 320 | | 320 | | | | | | |
| | | temperature 2 (° C.) | | | | | | | | | | | | | |
| | | Heat absorption | | | | 300 | 420 | | 255 | | | | | | |
| | | amount 2 (J/g) | | | | | | | | | | | | | |
| | Evaluation of | Formability | A | A | A | A | A | A | A | A | A | A | A | C | A |
| | sheet | Firing test | A | A | A | A | A | A | A | A | A | C | B | A | C |

TABLE 2

| | | Heat absorption |
|---|---|---|
| | | characteristics 2 |
| | Thickness | Reaching time to 160° C. |
| | (mm) | (min) |
| Reference | — | 4.5 |
| Ex. | | |
| Ex. 3 | 2.5 | 11.5 |
| Ex. 9 | 2.5 | 15 |
| Comp. Ex. 5 | 3 | 7.5 |

TABLE 3

| | Heat absorption |
|---|---|
| | characteristics 3 |
| | Reaching time to 160° C. |
| | (seconds) |
| Ex. 2 | 39 |
| Ex. 3 | 66 |
| Comp. Ex. 6 | 19 |

### Industrial Applicability

A secondary battery module of the present invention can suppress a rapid temperature rise of a secondary battery due to heat generation during high-speed charging or high-output discharging, and prevent ignition or damage due to thermal runaway, and therefore is useful for various applications as a secondary battery with improved safety.

### REFERENCE SIGNS LIST

1 heat-absorbing sheet
2 adhesive layer
3 flame shielding layer

1. A secondary battery module comprising a heat-absorbing sheet including a heat-absorbing agent and sandwiched between battery cells.

2. The secondary battery module according to claim 1, wherein the heat-absorbing sheet is a heat-absorbing sheet having a void part.

3. The secondary battery module according to claim 1, wherein the heat-absorbing sheet is a heat-absorbing sheet further including a heat storage material.

4. The secondary battery module according to claim 1, wherein the heat-absorbing sheet is a heat-absorbing sheet further having a flame shielding layer.

5. The secondary battery module according to claim 1, wherein the heat-absorbing sheet is a heat-absorbing sheet further having adhesive layers on outermost layers on both sides, and the battery cells are fixed by the adhesive layers.

6. The secondary battery module according to claim 1, wherein the heat-absorbing agent included in the heat-absorbing sheet is at least one or more types selected from the group consisting of inorganic hydrates, metal hydroxides, and carbonates.

7. The secondary battery module according to claim 1, wherein the heat-absorbing sheet is a heat-absorbing sheet including two or more kinds of heat-absorbing agents.

8. The secondary battery module according to claim 1, wherein the heat-absorbing sheet is a heat-absorbing sheet having a total thickness in a range of 100 to 20,000 μm.
